(19) United States
(12) Patent Application Publication
(10) Pub. No.: US 2012/0205967 A1
(43) Pub. Date: Aug. 16, 2012

(54) Main Brake Cylinder and Method for Operating a Main Brake Cylinder

(75) Inventor: Dirk Mahnkopf, Eglosheim (DE)

(73) Assignee: Robert Bosch GmbH, Stuttgart (DE)

(21) Appl. No.: 13/391,319

(22) PCT Filed: Aug. 2, 2010
(86) PCT No.: PCT/EP10/61178

§ 371 Date: Apr. 19, 2012

(30) Foreign Application Priority Data
Aug. 21, 2009 (DE) 10 2009 028 811.2

(51) Int. Cl. B60T 13/58; B60T 11/16; B60T 11/228; B60T 13/128

(52) U.S. Cl. 303/2; 60/585; 60/586

(57) ABSTRACT

The disclosure relates to a method and a device as part of a complete brake system, that is, a brake system comprising a conventional part and a further part, such as a recuperative part, by means of which volume displacements of brake fluid are possible. The method according to the disclosure and the device according to the disclosure are used particularly if the pressure conditions in the hydraulic part of the brake system are adapted by the controllable braking force amplifier to a change in the additional braking effect of the further part of the brake system. A blending of the braking effects of the different brake systems into a constant total braking effect is thus accomplished, even if the proportion of the individual brake systems in the total braking effect change.

### PRIOR ART

In a hydraulic brake system of a motor vehicle, a brake pedal is usually activated by the driver and mechanically moves, if appropriate with the assistance of a brake booster, a piston in a master brake cylinder to whose outputs a hydraulic assembly is connected. As a result, brake fluid is input into the hydraulic assembly (for example ESP or ABS) and conducted to the wheel brake cylinders. There, the input volume increases the brake pressure and brings about a braking effect by pressing the brake linings against the brake disks.

In vehicles in which an electric motor is provided for driving the motor vehicle, the electric motor can be used as a generator for, for example, charging a battery, in driving situations in which the electric motor is not used as a drive. The operation of the electric motor as a generator brings about a braking effect in which movement energy of the vehicle is converted into electrical energy, this is referred to as regenerative braking. The energy which is acquired during a braking operation can be used again in other ways at a later time, for example to drive the vehicle.

The generator torque which is contributed to the braking operation by the generator is generally dependent on the velocity of the motor vehicle and therefore changes during the braking operation, or the braking effect generated by the generator is not sufficient. In order to compensate this changing generator torque or else to supplement it, a regenerative brake system can be combined with a hydraulic brake system to form a composite brake system.

If a desired composite braking torque is predefined by the driver, for example by activation of a brake pedal, the hydraulic brake system can apply the difference between the composite braking torque and the generator torque, for example by increasing the pressure in the hydraulic brake system when the generator torque is too small compared to the composite braking torque desired by the driver. An increase in pressure, for example through a change in the effect of the brake booster in the hydraulic brake system, usually leads in conventional brake systems to a change in the activation travel of the brake pedal, which is irritating to the driver.

For this reason, the brake pedal is frequently connected to a pedal travel simulator for generating a pedal sensation for the driver, and the brake pedal is completely decoupled from the brake system and the build-up of pressure in the hydraulic brake system occurs purely through extraneous force, for example from an accumulator. However, this entails the risk that when the extraneous force fails there is no longer a mechanical coupling between the brake pedal and the wheel brake or there is mechanical coupling only after idle travel of the brake pedal has been overcome, and there is therefore no possibility of an emergency activation by the driver alone or without a conspicuous, irritating reaction for the driver.

WO 2004/101308 describes a method for changing pressure ratios in a hydraulic brake system in order to be able to operate the hydraulic brake system together with a regenerative brake system and therefore achieve a high level of braking comfort. For this purpose, in this document a volume of braking medium is discharged into a low pressure accumulator. Said volume can be fed back to the hydraulic brake circuit from this low pressure accumulator by activating a pump.

### DISCLOSURE OF THE INVENTION

The core of the invention is to provide a master brake cylinder according to the invention having the features of claim 1 for the hydraulic brake system, and to operate said master brake cylinder by the method according to the invention in such a way that a change in the pedal travel of a brake pedal owing to a change in the proportion of the composite braking effect carried out by the hydraulic brake system is counteracted, and an irritating reaction at the brake pedal is thereby avoided.

For this purpose, the master brake cylinder is composed of a first piston-cylinder arrangement, comprising a first cylinder and at least two pistons with a first cross-sectional area and a second piston-cylinder arrangement comprising a second cylinder and at least two pistons with a second cross-sectional area, wherein the first cross-sectional area is unequal to the second cross-sectional area. The first cylinder forms, with the first piston, an additional chamber in comparison with a conventional master brake cylinder. This chamber is used as an equalization chamber.

The master brake cylinder is advantageously connected, by means of a first hydraulic connection starting from the equalization chamber, to a volume-absorbing unit and, starting from the second cylinder, to further hydraulic connections which lead to respectively connected brake circuits. Furthermore, at least one second hydraulic connection is provided which connects the first hydraulic connection to at least one of the further hydraulic connections and therefore to at least one brake circuit.

In an advantageous refinement, the master brake cylinder is connected hydraulically, in each case in a disconnecting fashion, to a volume-absorbing unit and to the hydraulic brake system via the first piston-cylinder arrangement, that is to say via the equalization chamber. In order to disconnect the hydraulic connection, in each case controllable disconnection means are provided, the actuation of which permits the hydraulic connections to be disconnected.

The method according to the invention for operating a master brake cylinder is applied in a composite brake system, and the composite brake system comprises the hydraulic brake system and a further brake system in addition to the hydraulic brake system.

The master brake cylinder absorbs volumes of brake fluid into the first piston-cylinder arrangement or discharges the volume of brake fluid therefrom. In particular, the master brake cylinder discharges a volume of brake fluid from the second piston-cylinder arrangement. The absorption of volume or discharging of volume occurs as a function of an operating state of the further brake system.

The method according to the invention provides that the hydraulic brake system has a controllable brake booster by which the activation force applied by the driver is boosted with an assistance force, wherein the composite brake system has an activation element which comprises an input rod for absorbing the driver's force. Furthermore, the brake booster is operated in such a way that in the case of an increase in braking torque brought about by the further brake system the brake booster is reduced in its effect and/or in the case of a decrease in braking torque brought about by the further brake system the brake booster is increased in its effect in such a way that the composite braking torque which is applied by the composite brake system is essentially constant. Furthermore, there is provision, by absorption of volume and/or by discharging of volume by the master brake cylinder from the and/or into the at least one of the further hydraulic connections or from the and/or into the volume-absorbing unit, a change in the position of the activation element and/or of the input rod is counteracted, wherein this change in the position of the activation element and/or of the input rod is brought about by changing the assistance force applied by the brake booster and the resulting change in the volume absorption of the brake system. In particular, this change in the position of the activation element and/or the input rod is compensated entirely or at least partially. As a result, a driver does not notice an offset of the activation element, or only notices a small offset, and notices a change in the assistance force only to a slight degree or not at all.

The hydraulic brake system is part of a composite brake system which, in addition to the hydraulic brake system, has a further brake system. In a first embodiment of the method, by producing at least one of the first and second hydraulic connections, the volume of brake fluid is input, in particular automatically, from the first piston-cylinder arrangement into the volume absorbing unit or is absorbed, in particular automatically, from at least one of the further hydraulic connections into the first piston-cylinder arrangement, as a function of the operating state of the further brake system. It is therefore possible to exchange volumes of brake fluid between a volume-absorbing unit, the equalization chamber in the first piston-cylinder unit and the hydraulic brake circuit.

In the method according to the invention, the operating state of the further brake system is represented by a change in the contribution to the composite braking effect by the further brake system.

In the first embodiment of the method and in the case where the first cross-sectional area is larger than the second cross-sectional area, a volume is absorbed into the equalization chamber of the master brake cylinder from at least one of the further hydraulic connections when the contribution of the further brake system is increased, and a volume is discharged from the equalization chamber into the volume-absorbing unit when the contribution of the further brake system is reduced.

If, on the other hand, the first cross-sectional area is smaller than the second cross-sectional area, a volume is discharged from the equalization chamber into the connected brake circuit or into the second piston-cylinder arrangement when the contribution of the additional brake system rises.

If, on the other hand, the contribution of the further brake system is reduced, a volume is discharged from the second piston-cylinder arrangement or the connected brake circuit into the volume-absorbing unit.

In an alternative embodiment, by producing one of the hydraulic connections to the volume-absorbing unit or the hydraulic brake system, a volume of brake fluid is input, in particular automatically, into the first piston-cylinder arrangement, either from the volume-absorbing unit or from the hydraulic brake system, as a function of the operating state.

In the alternative embodiment of the method and in the case where the first cross-sectional area is larger than the second cross-sectional area there is provision that a volume is absorbed into the equalization chamber from the volume absorbing unit when the contribution of the further brake system is reduced, and a volume is absorbed into the equalization chamber from the hydraulic brake system when the contribution of the further brake system is increased.

If, on the other hand, the first cross-sectional area is smaller than the second cross-sectional area, a volume is discharged from the equalization chamber into the connected brake circuit or into the second piston-cylinder arrangement when the contribution of the further brake system is increased, and/or a volume is absorbed into the equalization chamber from the volume-absorbing unit (401) when the contribution of the further brake system is reduced.

For the specified embodiments, the absorption and/or discharging of volumes of brake fluid by the equalization chamber is controlled by controlling the first and/or second disconnection means. Therefore, by controlling the disconnection means it is possible to select whether the equalization chamber is hydraulically connected to the hydraulic brake circuit and the second piston-cylinder arrangement or to the volume-absorbing unit and absorbs volume from there or, if appropriate, discharges volume to there.

In one advantageous refinement of the method, the volume-absorbing unit is a piston-cylinder unit which is integrated into an activation element for the composite brake system, referred to below as an input chamber. In the alternative embodiment of the method, the volume-absorbing unit is a hydraulic accumulator unit which comprises at least one piston (403), at least one cylinder (402) and at least one elastic element (404), in particular a spring, which can store volumes under increased pressure.

In the method according to the invention there is provision that the hydraulic accumulator unit can be precharged by activating the controllable brake booster. In this way, the pressure level in the hydraulic accumulator unit is raised, and therefore also the pressure level at which the equalization chamber can automatically absorb a volume of brake fluid.

Since the method according to the invention includes the transportation of volume having to take place by control of the controllable disconnection means, in particular automatically, the cross-sectional areas of the first and second piston-cylinder arrangement and of the input chamber as well as the pressure which is present in the hydraulic accumulator unit have to be dimensioned with respect to the pressure which is present in the connected brake circuit or in the equalization chamber in such a way that a volume of brake fluid can be absorbed and/or discharged, in particular automatically absorbed and/or discharged, to and/or from the equalization chamber or, in particular, a volume can be discharged from the second piston-cylinder arrangement, within structurally conditioned limits.

The contribution of the change in the position of the activation element and/or of the input rod which is caused by operating the master brake cylinder in accordance with the invention depends on the cross-sectional areas of the first piston-cylinder unit, of the second piston-cylinder unit and of the volume-absorbing unit. Furthermore, the absolute value of the compensation of the change in the position of the activation element and/or of the input rod can be controlled by controlling the respective disconnection means within structurally conditioned limits, that is to say, for example, on the basis of the opening period of the disconnection means.

### DESCRIPTION OF THE DRAWINGS

FIG. 1: the master brake cylinder with equalization chamber which has a cross-sectional area which is larger than the cross-sectional area of the second piston-cylinder arrangement in conjunction with an input chamber which is integrated into the pedal.

FIG. 2: a method for operating a master brake cylinder with an equalization chamber when the setting of a generator torque is increased.

FIG. 3: a method for operating a master brake cylinder with an equalization chamber when the setting of a generator torque is decreased.

FIG. 4: a master brake cylinder with an equalization chamber which has a cross-sectional area which is larger than the cross-sectional area of the second piston-cylinder arrangement in conjunction with a hydraulic accumulator.

FIG. 5: An alternative embodiment of the master cylinder with an equalization chamber which has a cross-sectional area which is smaller than the cross-sectional area of the second piston-cylinder arrangement.

### EMBODIMENTS OF THE INVENTION

In one preferred embodiment, it is assumed that there is a composite brake system which is composed of a conventional hydraulic part (containing, for example, ESP and ABS components) and an additional part. For illustrative purposes it is assumed that the contribution of the additional part to the braking effect of the composite brake system originates from a regenerative brake system and is brought about by a generator torque. The conventional part of the brake system is composed of an activation device 114 by means of which a driver's force 102 can be input into the brake system. This driver's force can be combined with an assistance force 101, for example originating from a controllable brake booster, to a coupling element 115, for example to a reaction disk. The controllable brake booster can either be an electromechanical vacuum brake booster or a controllable vacuum brake booster with electrically switched valves, but further embodiments are also conceivable. In conventional hydraulic brake systems, the coupling element 115 transmits the sum of the driver's force 102 and the assistance force 101, if appropriate via a piston rod, to an input piston of a master brake cylinder. The resulting displacement of the input piston and, if appropriate, a second piston, causes a volume of brake fluid to be displaced into connected brake circuits and, when wheel brake cylinders are connected to the brake circuit, brings about a build up of pressure and ultimately a braking effect by the wheel brakes. Under certain circumstances, a valve arrangement according to an ESP/ABS feedback system can be intermediately connected between the wheel brakes and the master brake cylinder in order to regulate the brake pressure.

The core of the invention is then to combine the braking effect of a regenerative brake system brought about by a generator torque with a braking effect of the hydraulic brake system, brought about by the driver's force 102 and the assistance force 101, to form a composite braking effect. If the contribution to the composite braking effect of the regenerative system changes it is therefore possible, by activating the controllable brake booster, to adapt the pressure and therefore to adapt the braking effect of the hydraulic brake system. If the braking effect of the regenerative system decreases, then the assistance force 101 of the controllable brake booster therefore increases, the braking effect of the regenerative system increases and therefore the assistance force 101 of the brake booster is reduced. Since a change in the pressure ratios in the hydraulic brake system performed by the brake booster can cause a volume of brake fluid to flow back into the master brake cylinder or be displaced from it, the position of the activation device 114 therefore also changes, there being, as it were, a reaction of the hydraulic brake system. In contrast, the composite braking effect from the regenerative system and the hydraulic system remains constant. In order to restore a pedal position which is customary for the driver or to at least partially counteract a change in the pedal position, a master brake cylinder composed of two piston-cylinder arrangements is used as the device according to the invention.

A first piston-cylinder arrangement comprises a cylinder 105 and two pistons 106a and 106b, wherein the piston 106b is mechanically connected to the coupling element 115 and it can be subjected to the driver's force 102 and to the assistance force 101 by means of said coupling element 115. The cylinder 105 has a first cross-sectional area A1 and is structurally connected to a further, second piston-cylinder arrangement. The second piston-cylinder arrangement comprises two pistons 108a and 108b, wherein the piston 108b has a rigid mechanical connection to the piston 106a. The pistons 108a,b are surrounded by a cylinder 107. The cylinder 107 has a smaller cross-sectional area A2 than the cylinder 105.

The two pistons 108a, 108b as well as the cylinder 107 are known essentially as the tandem master brake cylinder such as is known in conventional hydraulic brake systems for operating two hydraulic brake circuits.

In the device according to the invention, hydraulic lines 111a and 111b are also connected to the two chambers which are formed by the cylinder 107 and by the respective pistons 108a and 108b. These hydraulic lines lead to hydraulic brake circuits and, if appropriate, with an intermediately connected hydraulic unit of an ESP/ABS feedback system for at least one wheel brake which is connected to the brake circuit.

The cylinder 105 also forms, with the pistons 106a and 106b, a chamber which is referred to below as an equalization chamber 120. Connected to the equalization chamber 120 is a hydraulic line which branches into two further hydraulic lines 109 and 110. The equalization chamber 120 is hydraulically connected to the hydraulic line 111b via line 110, and therefore to the at least one connected brake circuit and to the chamber of the second piston-cylinder arrangement facing the cylinder 105. The hydraulic line 110 can be disconnected by a controllable valve 113.

The further hydraulic line 109, which can also be disconnected by a valve 112 downstream of the junction, is hydraulically connected to a third piston-cylinder arrangement 104. The latter comprises a cylinder 116 and a piston 117. The driver's force 102 can be applied to the piston 117 via an input rod 118, and forces can be transmitted to the input rod 118. The chamber which is formed by cylinder 116 and piston 117 is referred to below as an input chamber 119. The input chamber 119 has the cross-sectional area A3. The third piston-cylinder arrangement is structurally integrated into the activation device 114. The controllable valves 112, 113 and the controllable valve 405, which is still to be defined below, are activated by a control unit, but this is not shown. This is advantageously the control unit of the brake booster which additionally controls the valves.

The method according to the invention will be described on the basis of two typical operating situations of the composite brake system.

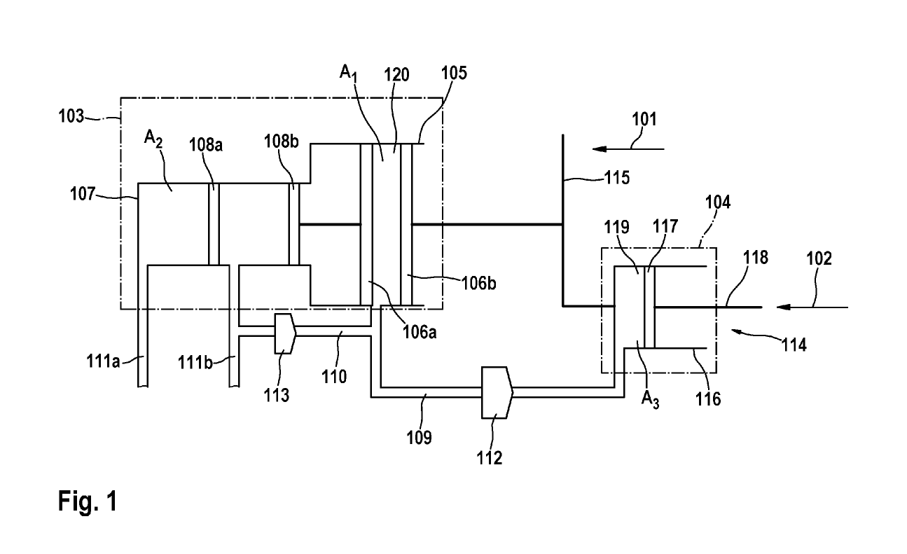

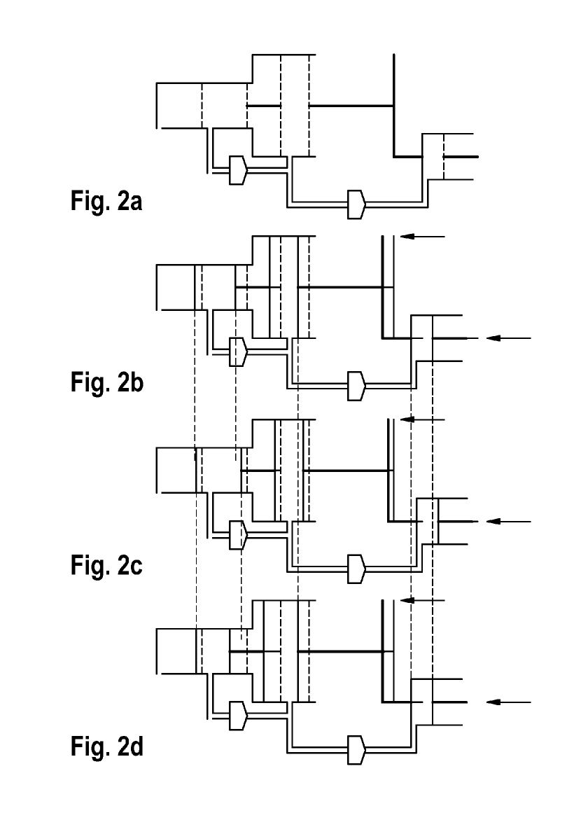

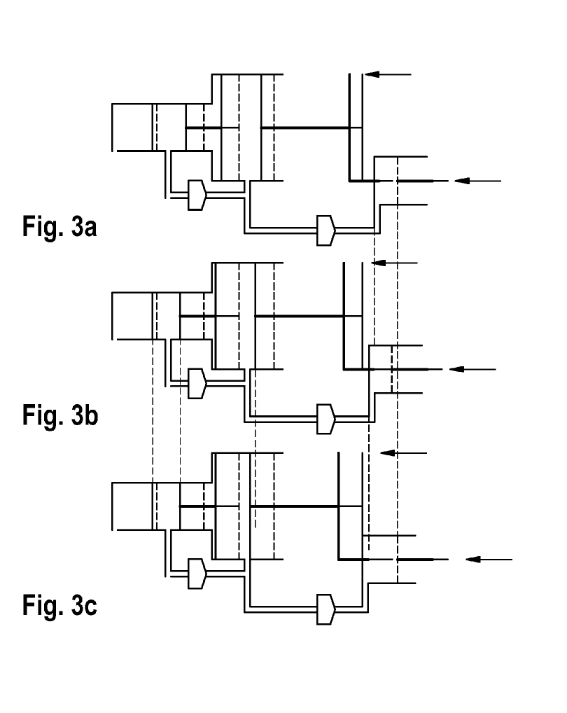

In a first operating situation, the driver brakes with just the hydraulic brake system, and then a generator torque of the regenerative brake system is added or increases. This operating situation is illustrated in FIG. 2. Since all the reference symbols have already been introduced in FIG. 1, they are not given again in FIGS. 2 and 3.

In FIG. 2a, the master brake cylinder 103 is in the unactivated state, neither a driver's force 102 or an assistance force 101 is applied to the coupling element 115.

FIG. 2b illustrates a situation in which the driver brakes with the hydraulic brake system alone. A driver's force 102 and an assistance force 101 are applied to the coupling element. The mechanical connection of the coupling element 115 to the piston 106b of the first piston-cylinder arrangement transmits the force to the piston 106b. As a result, the piston 106b is displaced in the cylinder 105 in the direction of the second piston-cylinder arrangement, and a volume of brake fluid as well as the piston 106a are displaced therewith.

In this context, the controllable valves 112 and 113 are both closed.

As a result of the mechanical connection of piston 106a and piston 108b, the piston 108b as well as a volume of brake fluid are displaced in the cylinder 107. This results in a displacement of piston 108a and a further displacement of brake fluid. The aforementioned displaced brake fluid passes via the hydraulic lines 111a and 111b into the brake circuits connected to the master brake cylinder 103, and leads there to a build-up of pressure in the wheel brake cylinders and therefore to a braking effect.

In FIG. 2c, a braking effect is added which is generated by driving a generator. In order to ensure constant deceleration in accordance with the position of the activation element 114, the absolute value of the assistance force 101 is reduced by the controllable brake booster. This reduction in the assistance force 101 leads to a situation in which brake fluid flows back into the master brake cylinder, and in which the pistons 106a,b and 108a,b are displaced counter to their activation direction, as is therefore also the activation element 114.

This reaction due to displacement of the activation element, which is irritating for the driver, can be counteracted according to the invention by controlling the valve 113.

For this purpose, in FIG. 2d the valve 113 is opened and a volume of brake fluid flows out of the brake circuit via hydraulic line 111b and 110 and back into the equalization chamber 120. This flow of brake fluid results from the different pressure levels in the brake circuit and the second piston-cylinder arrangement as well as in the equalization chamber 120. The valve 112 is kept closed in the process.

For a typical master brake cylinder, the diameter of the cross-sectional area A2 is 22.56 mm, which leads, given an assumed input force of 200N, to a pressure of approximately 5 bar.

If, for example, a driver's force 102 of 100N has an assistance force 101 of 500N added to it by the brake booster, the resulting force of 600N leads to a pressure of 15 bar in the second piston-cylinder arrangement if the latter has a cross-sectional area A2 with a diameter of 22.54 mm. Assuming that the cross-sectional area A1 of the equalization chamber 120 is half as large as the cross-sectional area A1 of the second piston-cylinder arrangement, a pressure of 7.5 bar is present in the equalization chamber. If the valve 113 is therefore opened, a volume of brake fluid can flow out of the first brake circuit and into the equalization chamber owing to the pressure difference.

If volume flows out of the brake circuit into the equalization chamber, the piston 108b in FIG. 2c moves to the left by a distance −ds, and the piston 106a which is rigidly connected to the piston 108b, therefore does likewise, followed by 106b. However, the volume which is absorbed into the equalization chamber leads to a change in distance between the pistons 106a and 106b by a distance ds/2. The piston 106b therefore moves to the left by an amount −ds+ds/2=−ds/2 in FIG. 2c.

The displacement of the pistons 108b, 106a and 106b, which results from the flowing back of brake fluid from the brake circuit owing to the reduction in the assistance force, is now intended to compensate this relative movement. If the volume of brake fluid is then set in such a way that the travel ds/2 corresponds precisely to the preceding displacement of the pistons 108b, 106a and 106b, the activation device 114 overall no longer moves.

The absolute value of the travel of the activation device which is compensated in this way can be set on the basis of the ratio of the cross-sectional areas and by performing open-looped or closed-loop control of the valve 113.

In a second operating situation, the driver brakes with a combination of the hydraulic brake system and the regenerative brake system, wherein a generator torque of the regenerative brake system is now switched off or decreases. The second operating situation is illustrated in FIG. 3. FIG. 3a corresponds to the state in FIG. 2d, and the driver brakes with a combination of the two brake systems involved.

In order now to compensate the contribution to the braking effect by the generator torque which is eliminated or which decreases, the assistance force 101 of the brake booster is, as is shown in FIG. 3b, increased, and due to displacement of the pistons 106a,b and 108a,b a volume of brake fluid is displaced into the connected brake circuits where the resulting increase in pressure in the connected wheel brake cylinders leads to an increase in the braking effect of the hydraulic brake system. As a result, the activation element 114 is also moved in the activation direction.

In order to be able to compensate this pedal displacement, the valve 112 is now opened and a volume of brake fluid passes out of the equalization chamber 120 into the input chamber 119 via the hydraulic line 109. Although the piston 106b, facing the activation element 114, of the equalization chamber 120 moves to the left, the input rod 118, moves owing to the absorption of volume by the input chamber, and the pedal therefore moves in the opposite direction to the activation direction for the purpose of boosting the braking force.

The different pressure levels also play a decisive role here. The pressure in the second piston-cylinder arrangement and in the brake system will be assumed to be p₂ and results from the driver's force 102 F_{FAHRER} and the cross-sectional area A₂ of the second piston-cylinder arrangement 107, 108a,b is obtained as

p₂=F_{FAHRER}(l+g)/A₂ (1)

where g is the boost factor of the brake booster.

As already stated in the first operating mode, the pressure p₁ in the equalization chamber 120 is half the pressure p₂ in the second piston-cylinder arrangement 107, 108a,b owing to the cross-sectional area A₁ being twice as large.

p₂=2p₁ (2)

The pressure p₃ in the input chamber is obtained as

p₃=F_{FAHRER}/A₃=F_{FAHRER}/A₂ (3)

where F_{FAHRER} corresponds to the driver's force 102, and A₃ is the cross-sectional area of the input chamber. The second equality sign applies here assuming that the cross-sectional area A₃ of the input chamber is equal to the cross-sectional area A₂ of the second piston-cylinder arrangement. If equations 1, 2 and 3 are combined, the following is obtained for the relevant relationship between the pressure p₃ in the input chamber and the pressure p₂ in the second piston-cylinder arrangement:

p₃=p₂/(l+g)=p₁2/(l+g)

For automatic transport of the volume of brake fluid from the equalization chamber 120 into the input chamber 119, the pressure p₁ must be higher than the pressure p₃. This is the case if the boost factor g is >1. This condition depends greatly on the involved cross-sectional areas and can be set by means of said cross-sectional areas.

For this method of travel compensation by means of the input rod 118, the quantity of volume which is exchanged between the equalization chamber 120 and the input chamber 119 can also be predefined or set by means of the respectively involved cross-sectional areas and by means of the actuation or closed-loop control of the valve 112.

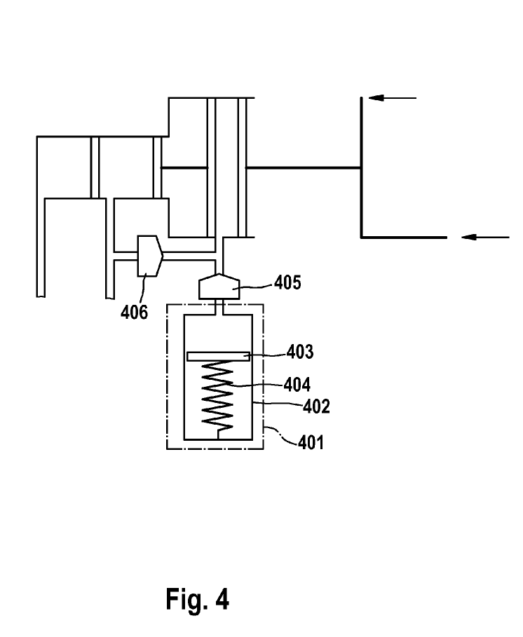

In an alternative embodiment of the invention, the equalization chamber 120 can be connected to a hydraulic accumulator 401 instead of to the input chamber 119.

Wherever the elements used in FIG. 4 are identical to those of FIG. 1, they have not been designated again. The hydraulic accumulator is comprised of a piston 403, a cylinder 402 and an elastic element, in particular a spring 404. A hydraulic accumulator device in the form of a diaphragm accumulator and/or a metal fold accumulator as well as any further volume-absorbing unit with a storage function are also conceivable.

The hydraulic connection between the hydraulic accumulator 401 and the equalization chamber 120 is formed via a hydraulic line which can be disconnected by means of a valve 405, in a way analogous to line 109 and valve 112 in FIG. 1. In addition, the hydraulic accumulator 401 is hydraulically connected to at least one connected brake circuit, in turn via a hydraulic line which can be disconnected with a valve, in a way analogous to line 110 and valve 113 in FIG. 1.

The accumulator can be precharged by activating the brake booster. For this purpose, the hydraulic connection from the master brake cylinder to the wheel brakes which are connected to the brake circuit is disconnected by a valve (not shown). This valve can be, for example, an inlet valve of an ESP or ABS hydraulic assembly. If the hydraulic connection is disconnected, the brake booster can be activated and can feed a volume of brake fluid into the hydraulic accumulator 401 via the master brake cylinder without a braking effect occurring. As a rule, the precharging takes place in situations in which the driver does not brake.

The hydraulic accumulator can also be precharged by further volume delivery units which are, if appropriate, already integrated into a hydraulic brake system, for example a hydraulic pump of an ESP assembly.

Furthermore, if the pressure ratios which are present in the accumulator and in the brake system permit, the hydraulic accumulator can be precharged by discharging a volume of brake fluid from the brake circuit. This procedure can take place either to compensate a pedal displacement, caused by a reduction in the proportion with respect to the overall braking effect of the brake booster when the generator torque is increasing, or when a braking operation is ending, if pressure is to be reduced in the brake system in any case. The position of the valves and the positioning of the valves in the hydraulic brake system is, if appropriate, to be adapted and taken into account in both alternative possibilities of how the accumulator is precharged.

Through feeding volume into the hydraulic accumulator, the elastic element 404 is compressed and therefore stores energy. The volume of brake fluid is stored by closing the valve 405 in the hydraulic accumulator 401.

After the precharging, the brake booster can be reset. The stored volume is therefore at a higher pressure level than the rest of the hydraulic brake system. In this embodiment of the device according to the invention when, for example, the generator torque decreases and the assistance force 101 is increased by the brake booster in order to generate a constant braking effect, a volume of brake fluid can be discharged from the accumulator 401 into the equalization chamber 120 or via line 111b into the connected brake circuit or into the second piston-cylinder arrangement. For this purpose, the valves 405 and 406 are correspondingly set. Due to the precharging, the volume of brake fluid in the hydraulic accumulator is, as already mentioned, at a raised pressure level and can therefore be discharged by simply positioning the valves, in an advantageous way without using a pump.

Furthermore, in a way analogous to the embodiment in FIG. 1, a pedal displacement, caused by a reduction in the proportion with respect to the composite braking effect of the brake booster when the generator torque is increasing can be counteracted by discharging a volume from the at least one connected brake circuit or from the second piston-cylinder arrangement into the equalization chamber 120 in which a relatively low pressure is present owing to the cross-sectional area of said equalization chamber 120.

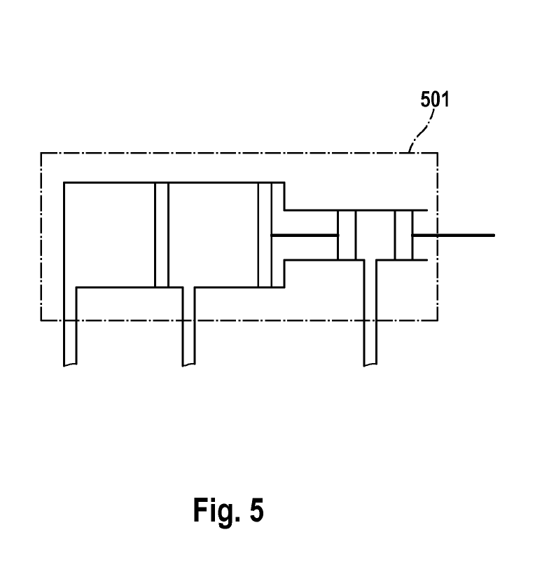

An alternative embodiment 501 of the master brake cylinder according to the invention is illustrated in FIG. 5. The reference symbols are retained.

This embodiment of the master brake cylinder differs from the embodiment 103 in FIG. 1 in that the cross-sectional area of the first piston-cylinder arrangement is smaller than the cross-sectional area of the second piston-cylinder arrangement.

The method according to the invention can also be applied in this embodiment. After adaptation of the braking effect by the brake booster, the master brake cylinder 501 can be used for travel compensation with a volume-absorbing unit 104 either with an input chamber 119 or with a hydraulic accumulator 401. In comparison with the embodiments of the method already described, the volume absorption or volume discharge from the master brake cylinder after increasing or decreasing the effect of the brake booster has to be adapted in order to compensate for a changing braking effect of the rest of the operating system.

If the master brake cylinder is connected to the input chamber 119, a volume is discharged from the first piston-cylinder arrangement 105, 106a,b into at least one of the other hydraulic connections 111a, b, that is to say into the connected brake circuit or into the second piston-cylinder arrangement 107, 108a,b if the contribution of the further brake system is increased and/or volume is discharged from the second piston-cylinder arrangement 107, 108a,b or from the connected brake circuit into the input chamber 119 when the contribution of the further brake system is reduced.

For the latter case of a reduced contribution of the further brake system to the braking effect, the cross-sectional area A3 of the input chamber must be smaller than the cross-sectional area A2 of the second piston-cylinder arrangement 107, 108,a,b.

If the master brake cylinder is connected to the hydraulic accumulator 401, volume is discharged from the first piston-cylinder arrangement 105, 106a,b into at least one of the further hydraulic connections 111a,b if the contribution of the further brake system is increased, and/or volume is absorbed into the first piston-cylinder arrangement 105, 106a,b from the hydraulic accumulator if the contribution of the further brake system is reduced.

A point which is important for all the embodiments is the possibility of operating the hydraulic brake system in a conventional way without volume compensation. For this purpose, the hydraulic connections 109 and 110 are disconnected so that no volume equalization is possible between the equalization chamber 120 and the input chamber 119, the hydraulic accumulator device 401 or the hydraulic brake system. In contrast to brake systems in which the brake pedal is only coupled to a pedal simulator and no longer to a hydraulic brake system, the present invention therefore has the advantage of continuing to have coupling of the brake pedal to the hydraulic brake system and therefore provides a fallback level for failure situations in which, for example, an assistance force is no longer available owing to a defect. In an emergency, braking can be carried out solely by means of the driver's force. In addition, the existing remaining coupling of the accelerator pedal to the hydraulic brake system can be additionally used to avoid any synthetic pedal sensation.

To summarize, it is possible to state that the invention describes a method and a device by means of which displacements of brake fluid volume are possible part of a composite brake system, that is to say a brake system composed of a conventional part and a further, for example regenerative, part. The method according to the invention and the device according to the invention are used, in particular, when the pressure ratios in the hydraulic part of the brake system are adapted by the controllable brake booster to a change in the additional braking effect of the further part of the brake system. Blending of braking effects of the different brake systems to form a constant composite braking effect is therefore made available, even if the proportion of the composite braking effect which is made up by the individual brake systems changes. Such an adaptation of pressure by the brake booster usually accompanies a reaction at the brake pedal, in particular with a displacement thereof. By exchanging a volume of brake fluid between at least one hydraulic brake circuit, one equalization chamber and either an input chamber in the brake pedal or a hydraulic accumulator it is possible for the pressure adaptation to take place without the driver realizing this at the brake pedal owing to a change in position of the pedal and finding it disruptive. The method can be used, for example, in vehicles in which a braking deceleration is caused by operating an electric machine as a generator for generating current and which additionally have a conventional hydraulic brake system as a further brake system or backup brake system.

1. A master brake cylinder for use in a hydraulic brake system, comprising:
a first piston-cylinder arrangement, including a first cylinder and at least two pistons with a first cross-sectional area; and
a second piston-cylinder arrangement including the second cylinder and at least two pistons with a second cross-sectional area,
wherein the first cross-sectional area and the second cross-sectional area are different.

2. The master brake cylinder as claimed in claim 1, further comprising:
starting from the first cylinder, a first hydraulic connection for a volume-absorbing unit;
starting from the second cylinder, further hydraulic connections configured to lead to respectively connected brake circuits; and
a second hydraulic connection configured to connect the first hydraulic connection to at least one of the further hydraulic connections.

3. The master brake cylinder as claimed in claim 2, wherein:
the hydraulic connection from the first piston-cylinder arrangement of the master brake cylinder to the volume-absorbing unit and to at least one of the further hydraulic connections can be respectively disconnected,
first controllable disconnection means are provided for disconnecting the first hydraulic connection, and
second controllable disconnection means are provided for disconnecting the second hydraulic connection.

4. A method for operating a master brake cylinder comprising:
absorbing volumes of brake fluid into a first piston-cylinder arrangement,
discharging volumes of brake fluid therefrom, as a function of the operating state of the further brake system, or
discharging volumes of brake fluid from the second piston-cylinder arrangement,
wherein the hydraulic brake system is part of a composite brake system, which includes a further brake system in addition to the hydraulic brake system,
wherein the first piston-cylinder arrangement includes a first cylinder and at least two pistons with a first cross sectional area,
wherein the master brake cylinder includes a second piston-cylinder arrangement including the second cylinder and at least two pistons with a second cross-sectional area, and
wherein the first cross sectional area and the second cross sectional area are different.

5. The method as claimed in claim 4, wherein:
the hydraulic brake system has a controllable brake booster by which the activation force applied by the driver is boosted with an assistance force,
the composite brake system has an activation element,
the activation element comprises an input rod for absorbing the driver's force,
the brake booster is operated in such a way that (i) in the case of an increase in braking torque brought about by the further brake system the brake booster is reduced in its effect and/or (ii) in the case of a decrease in braking torque brought about by the further brake system the brake booster is increased in its effect, in such a way that the composite braking torque which is applied by the composite brake system is essentially constant, and
the master brake cylinder is operated in such a way that by absorption of volume and/or by discharging of volume by the master brake cylinder from the and/or into the at least one of the further hydraulic connections or from the and/or into the volume-absorbing unit, a change in the position of the activation element and/or of the input rod which is brought about by changing the assistance force applied by the brake booster is counteracted, in particular in such a way that this change is entirely or at least partially compensated.

6. The method as claimed in claim 5, wherein, by producing at least one of the hydraulic connections to the volume-absorbing unit or to at least one of the further hydraulic connections, a volume of brake fluid is input, in particular automatically, from the first piston-cylinder arrangement into the volume-absorbing unit or is absorbed, in particular automatically, from at least one of the further hydraulic connections into the first piston-cylinder arrangement or into the volume-absorbing unit, as a function of the operating state of the further brake system.

7. The method as claimed in claim 6, wherein:
the first cross-sectional area is larger than the second cross-sectional area, and
the operating state of the further brake system is represented by a change in the contribution to the composite braking effect by the further brake system, wherein, in particular, there is provision that
a volume is absorbed into the first piston-cylinder arrangement from at least one of the further hydraulic connections when the contribution of the further brake system is increased, and/or
a volume is discharged from the first piston-cylinder arrangement into the volume absorbing unit when the contribution of the further brake system is reduced.

8. The method as claimed in claim 6, wherein:
the first cross-sectional area is smaller than the second cross-sectional area, and
the operating state of the further brake system is represented by a change in the contribution to the composite braking effect by the further brake system, wherein, in particular, there is provision that
a volume is discharged from the first piston-cylinder arrangement into at least one of the further hydraulic connections when the contribution of the further brake system is increased and/or
a volume is discharged from the second piston-cylinder arrangement into the volume-absorbing unit when the contribution of the further brake system is reduced.

9. The method as claimed in claim 5, wherein, by producing one of the hydraulic connections to the volume-absorbing unit or to at least one of the further hydraulic connections, a volume of brake fluid is input, in particular automatically, into the first piston-cylinder arrangement, either from the volume-absorbing unit or from at least one of the further hydraulic connections, as a function of the operating state of the further brake system.

10. The method as claimed in claim 9, wherein:
the first cross-sectional area is larger than the second cross-sectional area, and
the operating state of the further brake system is represented by a change in the contribution to the composite braking effect by the further brake system, wherein, in particular, there is provision that
a volume is absorbed into the first piston-cylinder arrangement from the volume-absorbing unit when the contribution of the further brake system is reduced and/or
a volume is absorbed into the first piston-cylinder arrangement from at least one of the further hydraulic connections when the contribution of the further brake system is increased.

11. The method as claimed in claim 9, wherein:
the first cross-sectional area is smaller than the second cross-sectional area, and
the operating state of the further brake system is represented by a change in the contribution to the composite braking effect by the further brake system, wherein, in particular, there is provision that
a volume is discharged from the first piston-cylinder arrangement into at least one of the further hydraulic connections when the contribution of the further brake system is increased, and/or
a volume is absorbed into the first piston-cylinder arrangement from the volume-absorbing unit when the contribution of the further brake system is reduced.

12. The method as claimed in claim 7, wherein the absorption and/or discharging of volumes of brake fluid by the first piston-cylinder arrangement is controlled by controlling the first and/or second disconnection means, in particular by absorption and/or discharging of brake fluid from and/or into the first piston-cylinder arrangement via the second hydraulic connection and/or via the first hydraulic connection by controlling the respective disconnection means.

13. The method as claimed in claim 4, wherein the volume-absorbing unit which is hydraulically connected to the master brake cylinder is a piston-cylinder unit which is integrated into the activation element or a hydraulic accumulator unit which comprises at least one piston, at least one cylinder and at least one elastic element, in particular a spring.

14. The method as claimed in claim 13, wherein the hydraulic accumulator unit can be precharged by controlled activation of the brake booster and the pressure level in the hydraulic accumulator is therefore raised so that the volume of brake fluid in the hydraulic accumulator is discharged automatically to the first piston-cylinder arrangement of the master brake cylinder or into at least one of the further hydraulic connections when the first hydraulic connection is produced and/or the second hydraulic connection is produced.

15. The method as claimed in claim 14, wherein:
the first and second cross-sectional areas of the first and second piston-cylinder arrangement as well as the cross-sectional areas of the piston-cylinder unit in the activation element and/or
the prestress and configuration of the at least one elastic element and/or
the hydraulic accumulator device with respect to the pressure present in at least one of the further hydraulic connections or in the first piston-cylinder arrangement is dimensioned in such a way that a volume of brake fluid can be absorbed and/or discharged, in particular automatically absorbed and/or discharged, to and/or from the first piston-cylinder arrangement or, in particular, a volume can be discharged from the second piston-cylinder arrangement, within structurally conditioned limits.

16. The method as claimed in claim 12, wherein the absolute value of the change in the position of the activation element and/or of the input rod by operating the master brake cylinder depends on the cross-sectional areas of the first piston-cylinder unit, of the second piston-cylinder unit and on the volume absorbing unit, and is controlled by controlling the respective disconnection means within structurally conditioned limits.
